(19) United States
(12) Patent Application Publication
(10) Pub. No.: US 2006/0225199 A1
(43) Pub. Date: Oct. 12, 2006

(54) Spa bath fitting and spa bath

(76) Inventors: John Hatrick-Smith, Meadowbank (NZ); Kip Marks, St. Heliers (NZ)

Correspondence Address: QUARLES & BRADY LLP, 411 E. WISCONSIN AVENUE, SUITE 2040, MILWAUKEE, WI, 53202-4497, US

(21) Appl. No.: 10/539,716

(22) PCT Filed: Dec. 22, 2003
(86) PCT No.: PCT/NZ03/00283

§ 371 Date: Mar. 10, 2006

(30) Foreign Application Priority Data
Dec. 20, 2002 (NZ) 523320

(51) Int. Cl. A61H 33/04

(52) U.S. Cl. 4/541.6

(57) ABSTRACT

A spa bath includes at least one spa jet fitting having a front face exposed to the interior of the bath cavity which does not protrude beyond the surface of the bath wall (B) around the spa fitting. Preferably at least a major portion of the front face of the fitting is substantially flush with the surrounding surface of the bath wall. A spa bath fitting includes a front part (2) including a wide diameter front face (1) which is exposed to the interior of the bath when the fitting is mounted in the side wall or base of a bath, a rear part (3) which is positioned on the rear side of the bath wall or base when the fitting is mounted in a bath and with which the front part is threadedly connected, and a back nut (4) mounted on the rear part for fixing the fitting in the bath wall or base.

### FIELD OF INVENTION

The invention relates to fittings as are used in spa baths and pools as spa outlets or jets, and inlet fittings.

### BACKGROUND OF THE INVENTION

A spa bath provides jets of water into the bath from a number of spa outlet fittings or spa jets positioned around the interior of the bath cavity. Generally water is drawn from the bath via an inlet fitting and is pumped through pipes around the exterior of the bath, which are boxed in or covered by panels during installation of the bath, and back into the bath through the spa jets.

Generally air is also delivered to the spa jets, which mixes as bubbles with the water delivered from the spa jets.

Conventionally spa jets include a raised adjustment ring which sits proud of the interior surface of the bath cavity. By rotating the adjustment ring a user may adjust the strength of the water flow exiting from the spa jet.

### SUMMARY OF THE INVENTION

It is an object of the invention to provide an improved or at least alternative form of spa bath fitting or spa bath.

In broad terms in one aspect the invention comprises a spa bath including at least one spa fitting having a front face exposed to the interior of the bath cavity which does not protrude beyond the surface of the bath wall around the spa fitting. Preferably at least a major portion of the front face of the spa fitting is substantially flush with the surrounding surface of the bath wall.

In broad terms in another aspect the invention comprises a spa bath fitting for mounting in a recess formed in the wall of a bath and having inwardly angled side walls, the fitting comprising a front part which is exposed to the interior of the bath in use and which includes an edge portion about the periphery of the front part which is tapered with reducing diameter toward a rear part of the fitting, which tapered peripheral edge portion of the front part assists in centering the fitting in the recess in the side wall of the bath.

In broad terms in another aspect the invention comprises a spa bath fitting for mounting in a recess formed in the wall of a bath and having inwardly angled side walls, the fitting comprising a rear part or back nut having a leading edge which contacts the rear surface of the recess in the bath wall, which leading edge is tapered with a reducing diameter toward a rear part of the fitting which assists in centering the fitting in the recess in the side wall of the bath.

In broad terms in another aspect the invention comprises a spa bath fitting including:
a front part including a wide diameter front face which is exposed to the interior of the bath when the fitting is mounted in a bath,
a rear part which is positioned on the rear side of bath wall when the fitting is mounted in a bath and with which the front part is threadedly connected, and
a back nut mounted on the rear part for fixing the fitting in the bath wall.

Such a fitting comprising separate threadedly coupled front and rear parts and a separate back nut for fixing the fitting to the bath enables the position of the front face of the fitting to be adjusted relative to the rear part separate from tightening of the back nut to fix the fitting in place. This enables fine adjustment during installation of the fitting of the position of the exposed front face of the front part relative to the bath wall.

Typically the fitting will be an outlet fitting or spa jet but alternatively the fitting may be an inlet fitting.

In this specification the term “spa bath” is intended to include spa baths and spa pools, including and also known as spas, whirlpools, and jacuzzis.

### BRIEF DESCRIPTION OF THE DRAWINGS

A preferred form spa bath outlet fitting or spa jet is described with reference to the accompanying drawings by way of example and without intending to be limiting, wherein:

FIG. 1 is a view from above a bath,

FIG. 2 is a side view of a preferred form fitting shown mounted in a section of bath wall,

FIG. 3 is a cross section view along line I-I of FIG. 2,

FIG. 4 is a view in the direction of arrow II of FIG. 2 of the front face of the spa jet (in a circular section of bath wall), and

FIG. 5 is perspective view of the spa jet in the section of bath wall.

### DETAILED DESCRIPTION OF PREFERRED FORM

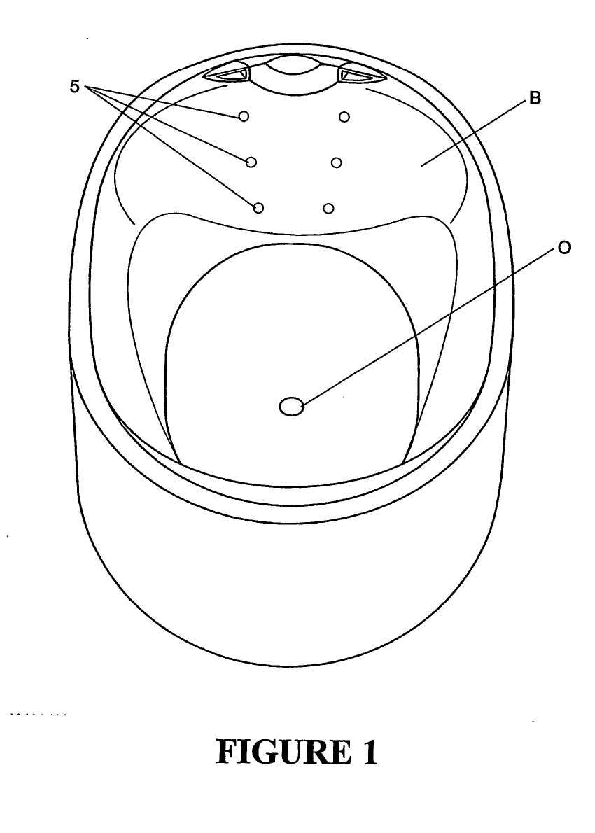

FIG. 1 shows a spa bath. Conventionally spa jets are mounted through an aperture formed in the bath wall at various locations around the bath and each fitting comprises a back body part which is positioned at the exterior (outside) of the bath wall and a front body part which screws from the other side of the bath wall into the back body part to fix the fitting in position in the bath wall. The bath includes an outlet fitting O.

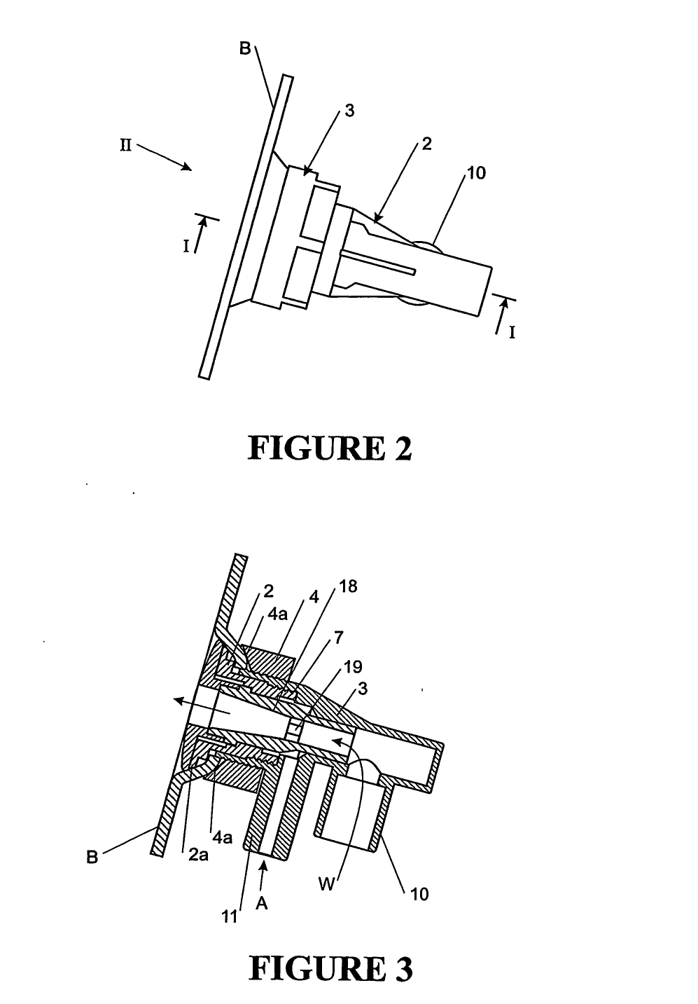

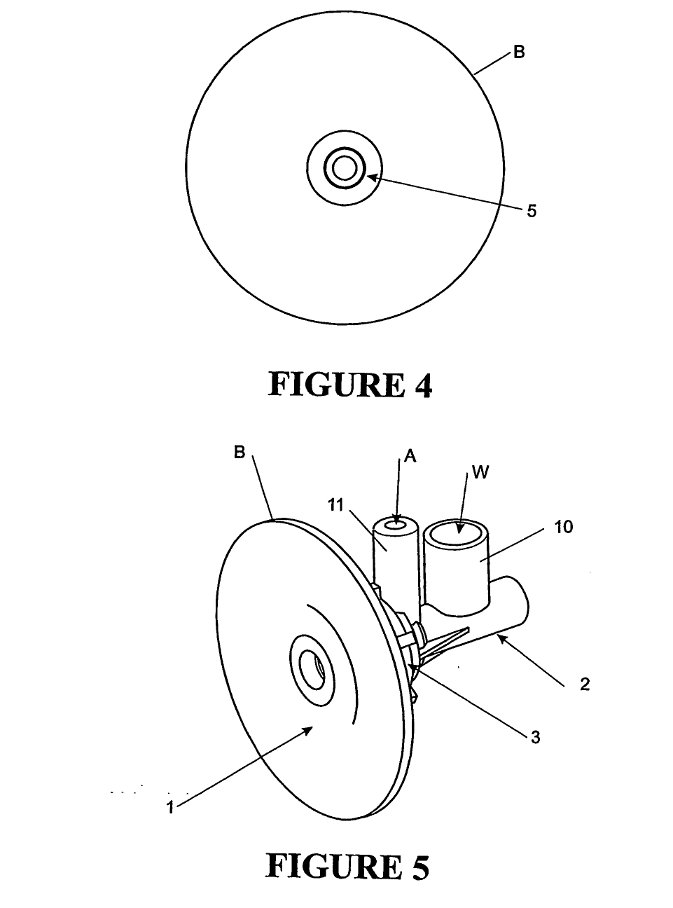

In FIGS. 2 to 5 a whole bath is not shown but only a circular section of bath wall indicated at B.

The preferred form spa jet fitting of the invention is mounted so that its front face does not protrude beyond, and over the major portion of its surface area is substantially flush with, the surrounding surface of the bath wall B.

The fitting comprises a front ring 1, a forward part 2, a rear part 3, a back nut 4. The forward part 2 includes a tail which passes through an aperture in the bath wall and has a threaded end which threadedly connects with the rear part 3 at 7. Back nut 4 threadedly mounts on the exterior of rear part 3 so that it can be screwed up against the rear side of the bath wall to lock the fitting in place in the bath wall.

To mount the spa jet the forward part 2 and rear part 3 are separated. The forward part 2 is inserted through the aperture in the bath wall from the inside of the bath, and is threaded into the rear part 3 carrying the back nut 4, which is positioned on the other side of the bath wall. The back nut 4 is then tightened on the rear part 3 against the rear surface of the bath wall, which fixes the fitting in the bath wall. The front ring 1 is then snap fitted into the forward part 2 to the position shown in the drawings. Alternatively the front ring 1 could be screw threaded into the forward part 2. In the preferred form as shown, when the forward ring 1 is in position the front face of the forward ring is substantially flush with the bath wall B.

The forward face 4a of the back nut 4 is inwardly tapered so that as the back nut 4 is tightened against the rear of the typically vacuum formed recess in the bath wall, this tends to self-centre the fitting.

The fitting is shown mounted in a recess formed in bath wall B, which recess has inwardly angled side walls. A tapered edge portion 2a about the periphery of forward part 2 is tapered with reducing diameter toward the rear fitting as shown, which also assists in centering the fitting.

A water pipe from the pump of the spa bath and an air pipe can connect to the fitting at 10 and 11 respectively. In FIG. 2 arrow W indicates the path of water through the spa jet in use, and arrow A indicates the path of air into the fitting to mix with the water.

In the preferred fitting the outer peripheral part of front ring 1 is sloped below the surrounding surface of the bath wall as shown, but in an alternative form the front face of ring 1 maybe flat and substantially flush with the surrounding bath wall over its entire diameter.

The preferred form fitting thus described comprises front ring 1, forward part 2, rear part 3, back nut 4. In an alternative form of the invention the fitting could comprise simply a body with a tubular tail which projects through the bath wall and a back nut which threads onto a tubular tail to clamp the fitting to the bath wall. In such a fitting the leading face of back nut 4 may still be tapered so that as the back nut is tightened against the rearside of a shaped recess with angled side walls in the bath wall, this leads to self centering of the fitting as described.

In another alternative form of the fitting the back nut may be integrally moulded with the rear part 3 of the fitting. That is, there is no separate back nut but the fitting is tightened in place by a forward part 2 of the fitting threading into a rear part 3 on either side of the bath wall. The leading face of the rear part 3 which engages the rear surface of the bath is preferably tapered as shown for the leading edge of the back nut 4. In use once the forward part of the fitting has been screwed into the rear part of the fitting to fix the fitting in the bath wall, then the front ring 1 is snap fitted or screwed into place.

The fitting may optionally include a central eyeball nozzle which enables the direction of the water jet from the fitting to be adjusted.

To assist adjustment of the spa jet by a bather in use the front face 1 may include one or more shallow recesses into which a users finger or fingers may fit to facilitate turning of the to adjust the air flow.

A flush mounted spa fitting as described provides a substantial additional user comfort relative to a fitting which is proud of the bath wall surface as is conventional (or recessed more deeply into the bath wall surface), and thus maybe provided in a wall section of a bath against which a bather will lean back in use for example, without causing discomfort to the user.

The fitting shown in the drawings is shown mounted in a flat portion of a bath wall but in an alternative form could be mounted in a slightly curved portion of the bath wall and the front face of front ring 1 may be slightly dished to remain as flush as possible with the bath wall surface.

The invention and the preferred form have been described above as a spa bath water outlet (or inlet) fitting but it is also possible that the invention may be used as a light fitting to mount a low voltage light in a spa bath base or wall or similar, in which event the front ring 1 of the fitting would include a glass panel with a bulb mounted behind the glass panel.

The foregoing describes the invention including a preferred form thereof. Alterations and modifications as will be obvious to those skilled in the art are intended to be incorporated in the scope hereof as defined in the accompanying claims.

1. A spa bath including at least one spa jet fitting having a front face exposed to the interior of the bath cavity which does not protrude beyond a surface of the bath wall around the spa jet fitting.

2. A spa bath according to claim 1 wherein at least a major portion of the front face of the spa jet fitting is substantially flush with the surface of the bath wall around the spa jet fitting.

3. A spa bath according to claim 1 wherein the spa jet fitting is a water jet outlet fitting and wherein the front face of the spa jet fitting comprises a ring which is rotatable to adjust water or air flow from the spa jet fitting.

4. A spa bath according to claim 3 wherein the front face of the spa jet fitting includes one or more shallow recesses into which a users finger or fingers may fit to facilitate rotation of said ring to adjust water or air flow from the spa jet fitting.

5. A spa bath according to claim 1 wherein the spa jet fitting is a water jet outlet fitting and includes a central eyeball nozzle which is movable to adjust the direction of water flow from the spa jet fitting.

6. A spa bath including at least one spa jet fitting mounted in a recess formed in the wall of the spa bath said recess having inwardly angled side walls, the spa jet fitting comprising a front part which is exposed to the interior of the bath and which includes an edge portion about the periphery of the front part which is tapered with reducing diameter toward a rear part of the spa jet fitting, which tapered peripheral edge portion of the front part seats in the recess in the side wall of the bath and centers the spa jet fitting.

7. A spa bath according to claim 6 wherein said front part includes a front ring which provides the wide diameter front face of the spa jet fitting.

8. A spa bath according to claim 6 wherein the spa jet fitting is a water jet outlet fitting and wherein the front face of the spa jet fitting comprises a ring which is rotatable to adjust water or air flow from the spa jet fitting.

9. A spa bath according to claim 8 wherein the front face of the spa jet fitting includes one or more shallow recesses into which a users finger or fingers may fit to facilitate rotation of said ring to adjust water or air flow from the spa jet fitting.

10. A spa bath according to claim 6 wherein the spa jet fitting includes a central eyeball nozzle which is movable to adjust the direction of water flow from the spa jet fitting.

11. A spa bath fitting for mounting in a recess formed in the wall of a bath said recess having inwardly angled side walls, the spa bath fitting comprising a rear part or back nut having a leading edge which contacts the rear surface of the recess in the bath wall, which leading edge is tapered with a reducing diameter toward a rear part of the fitting which assists in centering the spa bath fitting in the recess in the side wall of the bath.

12. A spa bath fitting according to claim 111 which comprises separate threadedly coupled front and rear parts and a separate back nut for fixing the spa bath fitting to the bath so as to enable the position of the front face of the spa bath fitting to be adjusted relative to the rear part separate from tightening of the back nut to fix the spa bath fitting in place, enabling adjustment during installation of the spa bath fitting of the position of the exposed front face of the spa bath fitting relative to the bath wall.

13. A spa bath fitting according to claim 12 wherein the fitting is a water jet outlet fitting and wherein the front face of the fitting comprises a ring which is rotatable to adjust the water or air flow from the spa bath fitting.

14. A spa bath fitting according to claim 12 wherein the front part includes a separate front ring which provides the wide diameter front face of the spa jet fitting.

15. A spa bath fitting according to claim 13 wherein the front face of the spa bath fitting includes one or more shallow recesses into which a users finger or fingers may fit to facilitate rotation of the to adjust water or air flow from the spa bath fitting.

16. A spa bath fitting according to claim 12 wherein the spa bath fitting is a water jet outlet fitting and includes a central eyeball nozzle which is movable to adjust the direction of water flow from the spa bath fitting.

17. A spa bath fitting including: a front part including a wide diameter front face which is exposed to the interior; of the bath when the spa bath fitting is mounted in the side wall or base of a bath, a rear part which is positioned on the rear side of the bath wall or base when the spa bath fitting is mounted in a bath and with which the front part is threadedly connected, and a back nut mounted on the rear part for fixing the spa bath fitting in the bath wall or base.

18. A spa bath fitting according to claim 17 wherein the front part includes a tail for passing through an aperture in the bath wall or base and which has a threaded end which threadedly connects with the rear part of the spa bath fitting and wherein the back nut threadedly mounts on the exterior of rear part of the spa bath fitting so that the back nut can be screwed up against the rear side of a bath wall or base to lock the spa bath fitting in place in the bath wall or base.

19. A spa bath fitting according to claim 18 wherein the tail of the front part of the spa bath fitting is externally threaded and the rear part comprises a complementary threaded bore into which the threaded tail of the forward part connects.

20. A spa bath fitting according to claim 17 wherein the front part includes a separate front ring which provides the wide diameter front face of the spa bath fitting.

21. A spa bath fitting according to claim 20 wherein the front ring snap-fit connects to another section of the forward part of the spa bath fitting.

22. A spa bath fitting according to claim 20 wherein the front ring screw threadedly connects to another section of the forward part of the spa bath fitting.

23. A spa bath fitting according to claim 17 wherein a forward face of the back nut is tapered to assist in self-centering the spa bath fitting during the tightening of the back nut against the rear of the bath wall or base.

24. A spa bath fitting according to claim 17 wherein a peripheral edge portion of the forward part is tapered with reducing diameter toward the rear part of the spa bath fitting to assist in centering the spa bath fitting in a recess in the wall or base of a bath.

25. A spa bath according to claim 17 wherein the spa bath fitting is a water jet outlet fitting and wherein the front face of the spa bath fitting comprises a ring which is rotatable to adjust the water or air flow from the spa bath fitting.

26. A spa bath fitting according to claim 25 wherein the front face of the spa bath fitting includes one or more shallow recesses into which a users finger or fingers may fit to facilitate rotation of the ring to adjust water or air flow from the spa bath fitting.

27. A spa bath fitting according to claim 17 wherein the spa bath fitting is a water jet outlet fitting and includes a central eyeball nozzle which is movable to adjust the direction of water flow from the fitting.
